(19) United States
(12) Patent Application Publication
(10) Pub. No.: US 2014/0061448 A1
(43) Pub. Date: Mar. 6, 2014

(54) MULTI-CHANNEL LUMINOUS ENERGY SENSING UNIT, APPARATUS FOR MEASURING LIGHT ENERGY OF EXPOSURE DEVICE AND METHOD FOR MEASURING LIGHT ENERGY BY CHANNEL

(71) Applicant: SAMSUNG ELECTRO-MECHANICS CO., LTD., Gyeonggi-do (KR)

(72) Inventors: Sang Yong Yu, Gyeonggi-do (KR); Sun Kyong Kim, Gyeonggi-do (KR); Seok Kim, Gyeonggi-do (KR); Jae Youn Jeong, Gyeonggi-do (KR); Ki Ju Jeon, Chungcheongnam-do (KR); Eun Hee Bong, Gyeonggi-do (KR)

(73) Assignee: SAMSUNG ELECTRO-MECHANICS CO., LTD., Gyeonggi-do (KR)

(21) Appl. No.: 14/012,969

(22) Filed: Aug. 28, 2013

(30) Foreign Application Priority Data
Aug. 31, 2012 (KR) 10-2012-0096125

(51) Int. Cl. G01J 1/04

(52) U.S. Cl. CPC G01J 1/0492
USPC 250/226

(57) ABSTRACT

The present invention relates to a multi-channel luminous energy sensing unit, an apparatus for measuring light energy of an exposure device and a method for measuring light energy by channel. In accordance with one embodiment of the present invention, a multi-channel luminous energy sensing unit to sense an amount of light illuminated from a light source, which includes a board; and a plurality of light sensor modules arranged on the board for sensing at least two channel light with bandwidths different from each other among the light illuminated from the light source, is provided. And also, an apparatus for measuring light energy of an exposure device including the same and a method for measuring light energy by channel are provided.

### CROSS-REFERENCE TO RELATED APPLICATIONS

This application claims the benefit of Korean Patent Application No. 10-2012-0096125 filed with the Korea Intellectual Property Office on Aug. 31, 2012, the disclosure of which is incorporated herein by reference.

### BACKGROUND OF THE INVENTION

1. Field of the Invention

The present invention relates to a multi-channel luminous energy sensing unit, an apparatus for measuring light energy of an exposure device and a method for measuring light energy by channel. In particular, the present invention relates to a multi-channel luminous energy sensing unit capable of accurately measuring wavelength bandwidth peaks of various types of spectrum energies of exposure light sources, an apparatus for measuring light energy of an exposure device and a method for measuring light energy by channel.

2. Description of the Related Art

The present invention relates to a multi-channel luminous energy sensing unit capable of analyzing spectrums in an exposure device used in an exposure process to react with a reactor such as a dry film for an exposure curing including a photo-initiator or an SR ink or the like by using a light source such as an Ultra Violet (UV), a visible (VIS), an IR (Infrared Radiation) and accurately measuring an accumulative energy by a multi-channel, an apparatus for measuring light energy of an exposure device and a method for measuring light energy by channel.

Gases or metal sources to form wavelength bandwidths of various types are included in the light sources used in the exposure device; and, accordingly, intrinsic energy peaks are determined by such sources.

In case of a conventional light luminous measurement device, various differences and various measurement regions exist in the sensors and optical beam paths. However, there are many cases that the sensitivities are difficult to accurately measure the main peak energy of specific wavelength bandwidths. Such reasons are that the whole UV region becomes a measurement target or a measurement bandwidth is unnecessarily wide. And also, the response hysterises in response to the wavelength of the sensor sensing part has influences mainly. This means that the sensor sensitivity is measured insensitively without specifying in the specific wavelength bandwidths. And also, as a criterion to manage the conventional exposure dose is limited to only I line, i.e., 365 nm, the factors of different peaks to affect the stiffness of a Solder Resist (SR) or a circuit cannot be measured.

### RELATED ART DOCUMENT

### Patent Document

Patent Document 1: Japan Patent Laid-open Publication No. 2007-327923 (published on Dec. 20, 2007)

### SUMMARY OF THE INVENTION

The present invention has been invented in order to overcome the above-described problems and it is, therefore, an object of the present invention to provide a multi-channel luminous energy sensing unit capable of accurately measuring wavelength bandwidth peaks of various types of spectrum energies of exposure light sources, an apparatus for measuring light energy of an exposure device and a method for measuring light energy by channel.

In accordance with one aspect of the present invention to achieve the object, there is provided a multi-channel luminous energy sensing unit to sense an amount of light illuminated from a light source, including: a board; and a plurality of light sensor modules arranged on the board for sensing at least two channel light with bandwidths different from each other among the light illuminated from the light source.

At this time, in one example, each of the light sensor modules includes: a neutral density (ND) filter for reducing the amount of light illuminated from the light source; a band pass filter (BPF) for passing a channel light with the specific bandwidth among the light passed through the ND filter; and a light sensor for sensing the amount of light of the channel light with the specific bandwidth passed through the BPF filter.

And also, each of the light sensor modules further includes: a window for passing the light illuminated from the light source; and a diffuser for diffusing the light passed through the window and supplying the diffused light to the ND filter.

And also, in one example, the plurality of light sensor modules includes: at least one first light sensor module arranged on the board for sensing an amount of light of a first channel light of a first wavelength bandwidth including a peak of substantially 365 nm among the light illuminated from the light source; at least one second light sensor module arranged on the board for sensing an amount of light of a second channel light of a second wavelength bandwidth, adjacent to the first wavelength bandwidth, including a peak of substantially 405 nm among the light illuminated from the light source; and at least one third light sensor module arranged on the board for sensing an amount of light of a third channel light of a third wavelength bandwidth, adjacent to the second wavelength bandwidth, including a peak of substantially 436 nm among the light illuminated from the light source.

At this time, the number of the first light sensor modules is greater than the number of the second and the third light sensor modules.

And also, at this time, in accordance with one example, the first wavelength bandwidth of the first channel light is ranging from substantially 345 to 385 nm, the second wavelength bandwidth of the second channel light is ranging from substantially 385 to 425 nm and the third wavelength bandwidth of the third channel light is ranging from 426 nm to 446 nm.

And also, in one example, the plurality of light sensor modules further comprises at least one light sensor module among at least one fourth light sensor module and at least one fifth light sensor module, wherein the at least one fourth light sensor module for sensing an amount of light of a fourth channel light of a fourth wavelength bandwidth, adjacent to the first wavelength bandwidth, including a peak of substantially 335 nm among the light illuminated from the light source, and the at least one fifth light sensor module for sensing an amount of light of a fifth channel light of a fifth wavelength bandwidth, adjacent to the fourth wavelength bandwidth, including a peak of substantially 315 nm among the light illuminated from the light source.

At this time, the fourth wavelength bandwidth of the fourth channel light is ranging from substantially 325 to 345 nm and the fifth wavelength bandwidth of the fifth channel light is ranging from substantially 305 to 325 nm.

In another example, the multi-channel luminous energy sensing unit further includes: at least one thermocouple module arranged on the board for measuring heat of the light illuminated from the light source.

At this time, in one example, the thermocouple module is formed by including a thermocouple sensor for measuring heat and a moisture sensor for measuring moisture.

And also, in another example, the multi-channel luminous energy sensing unit further includes: a moisture sensor module arranged on the board for measuring moisture.

Thereafter, in order to solve the above-described problems, in accordance with a second embodiment of the present invention to achieve the object, there is provided an apparatus for measuring light energy of an exposure device to measure spectrum energy of a light source of the exposure device, including: a multi-channel luminous energy sensing unit for measuring energy by channel of light illuminated from a light source of the exposure device according to any one of the above-described embodiments.

At this time, in one example, the multi-channel luminous energy sensing unit further includes at least one thermocouple module arranged on the board for measuring heat of the light illuminated from the light source.

Thereafter, in order to overcome the above-described problems, in accordance with a third embodiment of the present invention to achieve the object, there is provided a method for measuring light energy of light illuminated from a light source by channel, including: sensing channel light with at least two bandwidths different from each other by channel at the same time among the light illuminated to a board where a plurality of light sensor modules of which each senses an amount of light of a specific channel light are arranged by a specific channel; and calculating accumulated energy by channel from the amount of light sensed during a predetermined time.

At this time, in one example, sensing the channel light by channel at the same time includes: reducing an amount of light illuminated from the light source; passing a channel light with the specific bandwidth of the reduced light at the same time by channel; and sensing the amount of the past channel light of with the specific bandwidth at the same time.

And also, in one example, in sensing the channel light by channel at the same time, a first channel light of a first wavelength bandwidth including a peak of substantially 365 nm, a second channel light of a second wavelength bandwidth, adjacent to the first wavelength bandwidth, including a peak of substantially 405 nm and a third channel light of a third wavelength bandwidth, adjacent to the second wavelength bandwidth, including a peak of substantially 436 nm are sensed at the same time by channel.

At this time, in one example, the first wavelength bandwidth of the first channel light is ranging from substantially 345 to 385 nm; the second wavelength bandwidth of the second channel light is ranging from 385 to 425 nm; and the third wavelength bandwidth of the third channel light is ranging from 426 to 446 nm.

And also, at this time, in one example, in sensing the channel light by channel at the same time, the amount of light of at least one channel light among a fourth channel light and a fifth channel light may be further sensed at the same time, wherein the fourth channel light of a fourth wavelength bandwidth adjacent to the first wavelength bandwidth includes a peak of substantially 335 nm among the light illuminated from the light source and the fifth channel light of a fifth wavelength bandwidth adjacent to the fourth wavelength bandwidth includes a peak of substantially 315 nm.

At this time, the fourth wavelength bandwidth of the fourth channel light is ranging from substantially 325 to 345 nm; and the fifth wavelength bandwidth of the fifth channel light is ranging from substantially 305 to 325 nm.

And also, the method for measuring light energy of light illuminated from a light source by channel further includes: measuring heat of the light illuminated from the light source to the board at the same time of sensing the channel light by channel at the same time.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an Hg arc discharge spectrum graph representing a channel bandwidth sensed by using a multi-channel luminous energy sensing unit in accordance with an embodiment of the present invention;

FIG. 2a and FIG. 2b are schematic diagrams showing multi-channel luminous energy sensing units in accordance with embodiments of the present invention; and

FIG. 3 is a schematic diagram showing a light sensor module of a multi-channel luminous energy sensing unit in accordance with another embodiment of the present invention.

### DETAILED DESCRIPTION OF THE PREFERABLE EMBODIMENTS

Embodiments of the present invention for achieving the above objects will be described with reference to the accompanying drawings. In the specification, like reference numerals denote like elements, and duplicate or redundant descriptions will be omitted for conciseness.

It will be understood that when an element is referred to as being ‘connected to’ or ‘coupled to’ another element, it may be directly connected or coupled to the other element or at least one intervening element may be present therebetween. In contrast, when an element is referred to as being ‘directly connected to’ or ‘directly coupled to’ another element, there are no intervening element therebetween.

It should be noted that the singular forms ‘a’ ‘an’ and ‘the’ are intended to include the plural forms as well, unless the context clearly indicates otherwise. It should be understood that the terms ‘comprise’, ‘include’ and ‘have’, when used in this specification, specify the presence of stated features or elements, but do not preclude the presence or addition of one or more other features, elements, or combinations thereof.

The drawings referred to in the present specification will be described exaggeratedly in a shape, a size, a thickness or the like in order to effectively explain the technical features of the present invention as an example to represent the embodiments of the present in the present invention.

At first, a multi-channel luminous energy sensing unit, an apparatus for measuring light energy of an exposure device and a method for measuring light energy by channel in accordance with exemplary embodiments of the present invention will be described in detail with reference to the accompanying drawings. At this time, the reference numerals not shown in the referred drawings may be the reference numerals representing the same elements of the other drawings.

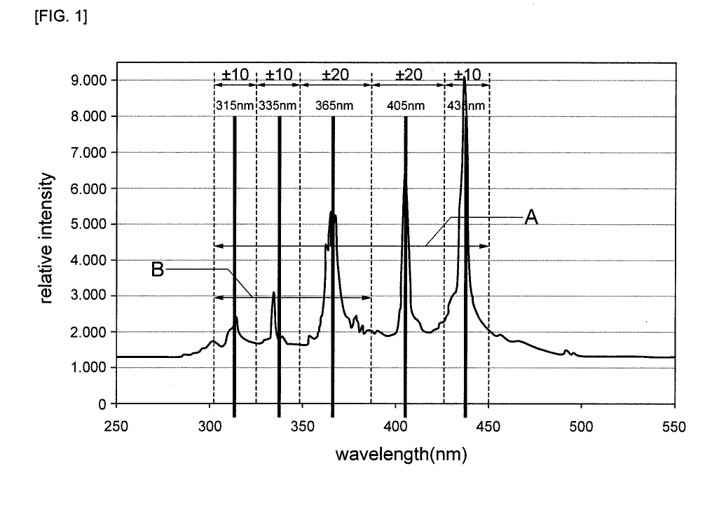

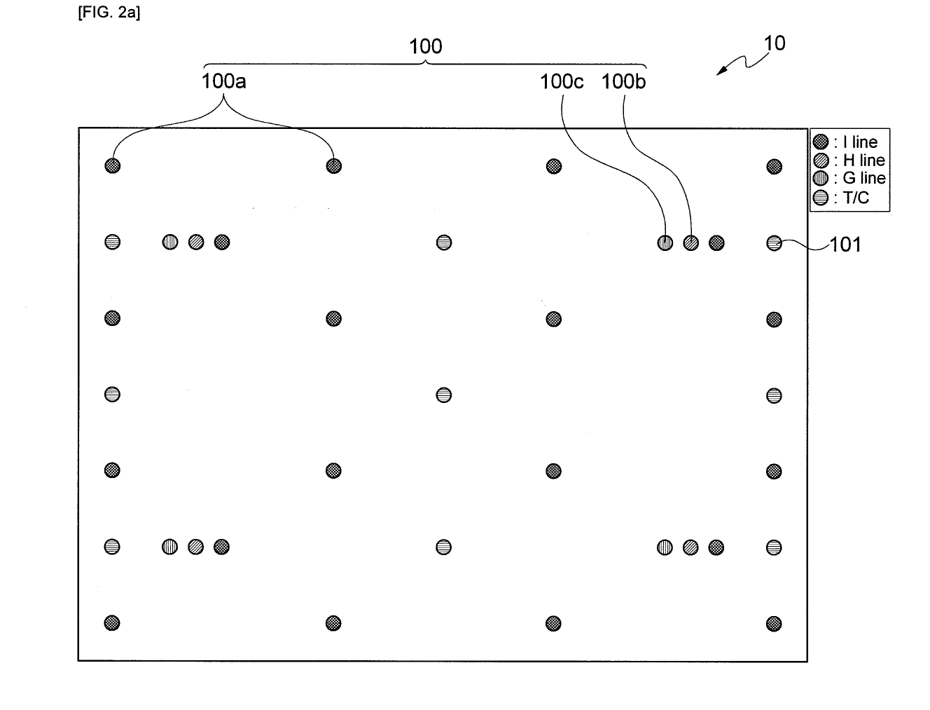

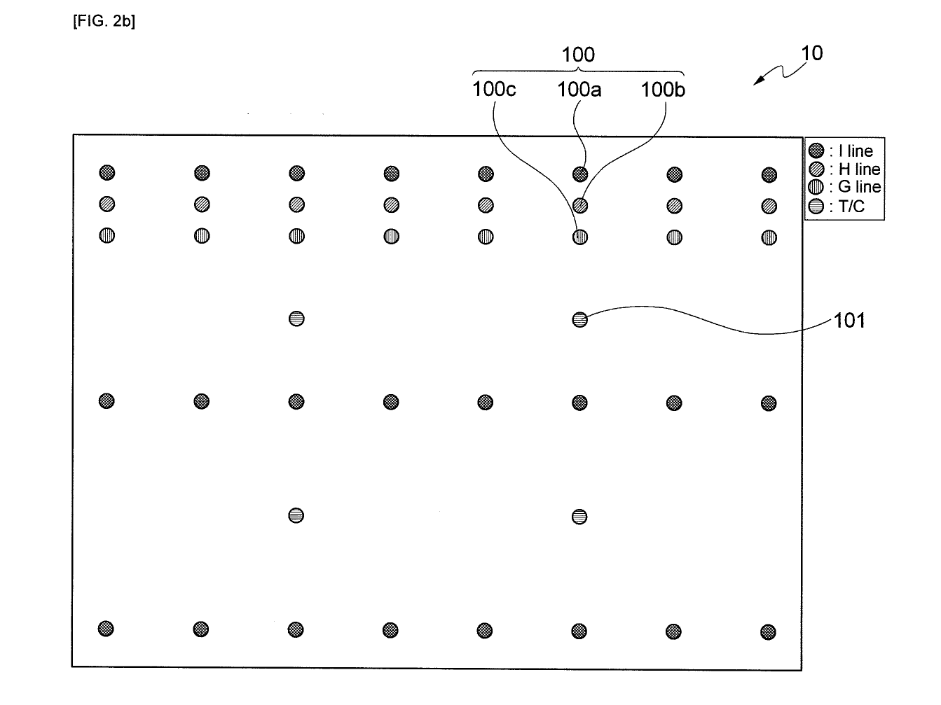

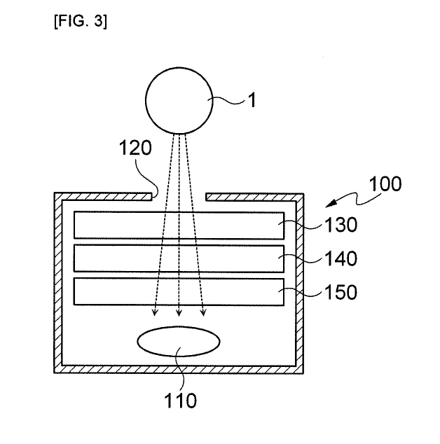

FIG. 1 is an Hg arc discharge spectrum graph representing a channel bandwidth sensed by using a multi-channel luminous energy sensing unit in accordance with an embodiment of the present invention. FIGS. 2a and FIG. 2b are schematic diagrams showing multi-channel luminous energy sensing units in accordance with embodiments of the present invention; and FIG. 3 is a schematic diagram showing a light sensor module of a multi-channel luminous energy sensing unit in accordance with another embodiment of the present invention.

Referring to FIGS. 2a, 2b and 3, the multi-channel luminous energy sensing unit 10 in accordance with an embodiment of the present invention senses an amount of light illuminated from a light source 1. At this time, the multi-channel luminous energy sensing unit 10 includes a board and a plurality of light sensor modules 100 arranged on the board to sense channel light having at least two bandwidths different from each other among the light illuminated from the light source 1. At this time, at least two bandwidths different from each other may be neighboring bandwidth, for example, may be bandwidths to be adjacent continuously. For example, as at least two bandwidths different from each other are adjacent continuously, an amount of light can be measured accurately per each bandwidth without a wavelength period omitted in a whole period. Accordingly, the accurate light amount measurement can be allowed for the bandwidth including different peaks which affect stiffness of as SR or a circuit as well as only one specific bandwidth.

And also, referring to FIGS. 2a and 2b, the multi-channel luminous energy sensing unit 10 in accordance with another embodiment of the present invention can further include at least one thermocouple module 101.

The multi-channel luminous energy sensing unit 10 in accordance with another embodiment of the present invention will be reviewed in detail referring to FIG. 3. At this time, in one example, each of the light sensor modules 100 arranged on the board can include a neutral density (ND) filter 140, a band pass filter (BPF) 150 and a light sensor 110. And also, in one example, referring to FIG. 3, each of the light sensor modules 100 can further include a window 120 and a diffuser 130.

Referring to FIG. 3, the ND filter 140 reduces the amount of light illuminated from the light source 1. For example, after the light entered through the window 120 are diffused by the diffuser 130, they enter into the ND filter 140 and the intensity of light is decreased in the ND filter 140. In the present embodiments, by being provided with the ND filter 140, the spectrum intensity is lowered at first and a corresponding region is filtered, thereby allowing a high resolution to be measured accurately.

Thereafter, the BPF 150 of the light sensor module 100 in FIG. 3 passes the channel light of a specific bandwidth among the light passing through the ND filter 140. A wavelength bandwidth to be sensed in the light sensor module 100 is determined according to the a passing bandwidth of the BPF 150.

And then, the light sensor 110 in FIG. 3 can sense the light amount of the channel light of the specific bandwidth passing through the BPF 150.

And also, according to one example, the window 120 of the light sensor module 100 passes the light illuminated from the light source 1. The reference numeral 120 in FIG. 3 represents the window to pass the light illuminated from the light source 1.

Thereafter, in FIG. 3, the diffuser 130 of the light sensor module 100 diffuses the light passing through the window 120 to supply the diffused light to the ND filter 140.

And then, referring to FIGS. 2a and 2b, the multi-channel luminous energy sensing unit 10 in accordance with another embodiment of the present invention will be reviewed in detail referring to FIG. 3. At this time, the plurality of light sensor modules 100 can be made of at least one first light sensor module 100a, at least one second light sensor module 100b and at least one third light sensor module 100c. And also, although not shown explicitly, referring to FIG. 1, the multi-channel luminous energy sensing unit 10 in accordance with another embodiment of the present invention can further include at least one among at least one fourth light sensor module (not shown) and at least one fifth light sensor module (not shown).

At this time, the arrangement of each light sensor module 100 may be changed according to the number of the light sources 1. For example, FIG. 2a shows the multi-channel luminous energy sensing unit 10 to sense the light amount of the light illuminated from one light source 1, wherein each of the light sensor modules 100 are uniformly arranged on the board. And also, for example, FIG. 2b shows the multi-channel luminous energy sensing unit 10 to sense the light amount of light illuminated from the eighth light sources arranged in a column continuously, wherein each of the light sensor modules 100 is arranged on the board in a column.

Referring to FIGS. 2a and 2b, at least one first light sensor modules 100a is arranged on the board. At this time, the first light sensor module 100a senses the light amount of the first channel light of the first wavelength bandwidth including a peak of substantially 365 nm among the light illuminated from the light source 1. For example, the first wavelength bandwidth can be in neighborhoods with a second wavelength bandwidth to be mentioned after.

For example, the first wavelength bandwidth of the first channel light may be in the range from substantially 345 to 385 nm. That is, it can have a filter window width of ±20 nm around the peak of substantially 365 nm. Accordingly, the channel light passing through the filter window width of ±20 nm around the peak of substantially 365 nm may be sensed.

In one example, the number of the first light sensor modules 100a may be larger than that of the third light sensor modules 100b.

And then, referring to FIGS. 2a and 2b, at least one second light sensor modules 100b is arranged on the board. At this time, the second light sensor module 100b senses the light amount of the second channel light of the second wavelength bandwidth including the peak of substantially 405 nm among the light illuminated from the light source 1. At this time, the second wavelength bandwidth can be in neighborhoods with the first wavelength bandwidth and a third wavelength bandwidth to be mentioned after. For example, in case when the second wavelength bandwidth can be neighborhoods without being overlapped with the first wavelength bandwidth and the third wavelength bandwidth. Only, in case when the second wavelength bandwidth is in neighborhoods with the first wavelength bandwidth and the third wavelength bandwidth, although a portion thereof is overlapped by an error of the filter to determine the wavelength bandwidth, it is not deviated from the scope of the present invention.

According to one example, the second wavelength bandwidth of the second channel light may be a range from substantially 385 to 425 nm. That is, it may have a filter window width of ±20 nm around the peak of substantially 405 nm.

Sequentially, referring to FIGS. 2a and 2b, at least one third light sensor modules 100c is arranged on the board. At this time, the third light sensor module 100c senses the light amount of the third channel light of the third wavelength bandwidth including the peak of substantially 436 nm among the light illuminated from the light source 1. For example, the third wavelength bandwidth can be in neighborhoods not so as to be overlapped with the second wavelength bandwidth. Although in the present specification the wavelength bandwidths are described not to be overlapped, since the filter to determine the wavelength bandwidth may have an error of a few nanometers, e.g., 2˜3 nm, it must not be interpreted as a case that a portion is substantially overlapped is completely excluded.

According to one example, the third wavelength bandwidth of the third channel light may be a range from 426 nm to 446 nm. That is, it can have a filter window width of ±10 nm around the peak of substantially 436 nm. Or, the third wavelength bandwidth may be a range from 425 nm to 445 nm in the light of the continuity or/and the filter error with the second wavelength bandwidth.

Thereafter, although not shown explicitly, referring to FIG. 1, the multi-channel luminous energy sensing unit 10 in accordance with another embodiment of the present invention can further include at least one light sensor module among at least one fourth light sensor module (not shown) and at least one fifth light sensor module (not shown).

At this time, the fourth light sensor module (not shown) can sense the light amount of the fourth channel light of the fourth wavelength bandwidth being in neighborhoods with the first wavelength bandwidth including the peak of the 335 nm among the light illuminated from the light source 1. For example, the fourth wavelength bandwidth can be in neighborhoods not so as to be overlapped with the first wavelength bandwidth.

At this time, in one example, the fourth wavelength bandwidth of the fourth channel light may be a range from substantially 325 to 345 nm.

Thereafter, the fifth light sensor module (not shown) includes the peak of substantially 315 nm among the light illuminated from the light source 1, wherein it can sense the light amount of the fifth channel light of the fifth wavelength bandwidth neighboring with the fourth wavelength bandwidth. For example, the fifth wavelength bandwidth can be in neighborhoods not so as to be overlapped with the fourth wavelength bandwidth.

At this time, in one example, the fifth wavelength bandwidth of the fifth channel light may be a range from substantially 305 to 325 nm.

And also, although not shown, the multi-channel luminous energy sensing unit 10 in accordance with another embodiment of the present invention can further include at least one light sensor module to sense the light amount of a channel light having a wavelength bandwidth including other small peaks. For example, it can further include at least one light sensor module to sense the light amount of the channel light having a bandwidth including the peak of 550 nm or/and a bandwidth including the peak of 580 nm.

And also, referring to FIGS. 2a and 2b, the multi-channel luminous energy sensing unit 10 in accordance with still another embodiment of the present invention can further include at least one thermocouple module 101.

In FIGS. 2a and 2b, the thermocouple module 101 is arranged on the board, wherein it can measure the heat of the light illuminated from the light source 1.

At this time, in one example, the thermocouple module 101 can be consisted of a thermocouple sensor to measure the heat and a moisture sensor to measure the moisture.

And also, although not shown, in another example, the multi-channel luminous energy sensing unit 10 can further include a moisture sensor module. At this time, the moisture sensor module is arranged on the board, wherein it can measure the moisture.

Thereafter, an apparatus for measuring a light energy of an exposure device in accordance with a second embodiment of the present invention will be described in detail. At this time, the multi-channel luminous energy sensing unit 10 in accordance with the first embodiment of the present invention will be referred; and, accordingly, the overlapped explanations will be omitted.

The main spectrums of the light source 1 used In the exposure device have various types, for example, the UV energy required for the curing can be obtained by using a high pressure Hg arc discharge lamp. FIG. 1 represents a spectrum of a conventional Hg arc discharge lamp, wherein the channel bandwidth to be sensed by using the multi-channel luminous energy sensing unit 10 of the apparatus for measuring the light energy of the exposure device is shown.

In FIG. 1, the main peaks of which central peaks are correspond to 365 nm, 405 nm and 436 nm represented as I, H and G, wherein sub peaks exist in 315 nm and 345 nm. In the present invention, the accumulative energy of the plurality of main peaks, e.g., the three main peaks I, H and G, affecting on a dry film and a solder resist (SR) ink directly or additional sub peaks except the three main peaks I, H and G can be calculated at once in the multi-channel luminous energy sensing unit 10. And also, the light amount as well as temperature or the temperature and the moisture can be measured at a large area.

The apparatus for measuring the light energy of the exposure device in accordance with the second embodiment of the present invention can measure the spectrum energy of the light source 1 of the exposure device. At this time, the apparatus for measuring the light energy of the exposure device can be made of by including the multi-channel luminous energy sensing unit 10 according to anyone among the above-mentioned first embodiments to measure the energy for each of the channels of the light illuminated from the light source 1 of the exposure device. At this time, the multi-channel luminous energy sensing unit 10 of the apparatus for measuring the light energy of the exposure device can be made of by including a board and a plurality of light sensor modules 100 arranged on the board to sense the channel light of at least two bandwidths different from each other among the light illuminated from the light source 1. At this time, at least two different bandwidths may be neighborhood bandwidths, for example, may be the bandwidths to be in neighborhoods with each other continuously. For example, as at least two different bandwidths are continuously in neighborhoods with each other, accurate light amounts for each bandwidth can be measured without omitted wavelength periods in the whole period.

At this time, in one example, the light sensor module 100 arranged on the board can include an ND filter 140, a band pass filter (BPF) 150 and a light sensor 110. And also, in one example, each of the light sensor modules 1000 can further include a window 120 and a diffuser 130.

And also, in one example, a plurality of light sensor modules 100 can be made of by including at least one first light sensor module 100a, at least one second sensor module 100b and at least one third light sensor module 100c.

At this time, the first light sensor module 100a of the multi-channel luminous energy sensing unit 10 can sense the light amount of the first channel light of the first wavelength bandwidth including the peak of substantially 365 nm among the light illuminated from the light source 1. For example, the first wavelength bandwidth of the first channel light may be a range from substantially 345 to 385 nm.

And also, the second light sensor module 100b of the multi-channel luminous energy sensing unit 10 can sense the light amount of the second channel light of the second wavelength bandwidth including the peak of substantially 405 nm among the light illuminated from the light source 1. For example, the second wavelength bandwidth of the second channel light may be a range from substantially 385 to 425 nm.

Subsequently, the third light sensor module 100c of the multi-channel luminous energy sensing unit 10 can sense the light amount of the third channel light of the third wavelength bandwidth including the peak of substantially 436 nm among the light illuminated from the light source 1. For example, the third wavelength bandwidth of the third channel light may be a range from 426 nm to 446 nm.

And also, in the apparatus for measuring a light energy of an exposure device in accordance with another embodiment of the present invention, the multi-channel luminous energy sensing unit 10 can further include at least one light sensor module among at least one fifth light sensor module (not shown) including a peak of substantially 335 nm to sense the light amount of the fourth channel light of the fourth wavelength bandwidth being in neighborhoods with the first wavelength bandwidth and at least fifth light sensor module (not shown) including a peak of substantially 315 nm to sense the light amount of the fifth channel light of the fifth wavelength bandwidth being in neighborhoods with the fourth wavelength bandwidth. At this time, in one example, the fourth wavelength bandwidth may be ranged from substantially 325 to 345 nm and the fifth wavelength bandwidth of the fifth channel light may be ranged from substantially 305 to 325 nm.

In one example, the multi-channel luminous energy sensing unit 10 of the apparatus for measuring a light energy of an exposure device can further include at least one thermocouple module 101 arranged on the board to measure the heat of the light illuminated from the light source 1. At this time, in one example, the thermocouple module 101 can be made of by including a thermocouple sensor to measure the heat and a moisture sensor to measure the moisture.

Thereafter, a method for measuring a light energy by channel in accordance with a third embodiment of the present invention will be described in detail. At this time the multi-channel luminous energy sensing unit 10 in accordance with the above-described first embodiment and the apparatus for measuring a light energy of an exposure device in accordance with the above-described second embodiment may be referred; and, accordingly, the overlapped explanations will be omitted.

In FIG. 1, the main peaks of which central peaks are correspond to 365 nm, 405 nm and 436 nm represented as I, H and G, wherein sub peaks exist in 315 nm and 345 nm. The energy of the main peaks and the sub peaks corresponds to an accumulative energy, and if it is represented as the sum of times again, it can be calculated as the accumulative energy. In the present invention, the accumulative energy of the plurality of main peaks, e.g., the three main peaks I, H and G, affecting on a dry film and a solder resist (SR) ink directly or additional sub peaks except the three main peaks I, H and G can be calculated at once in the multi-channel luminous energy sensing unit 10. For example, in FIG. 1, A represents a light amount measuring range during the circuit exposure and B represents the exposure measurement range.

And also, the light amount as well as temperature or the temperature and the moisture can be measured at a large area.

The method for measuring the light energy by channel in accordance with the third embodiment of the present invention is related to a method for measuring the energy of the light illuminated from the light source 1 by channel, wherein it is consisted of by including a step of sensing the channel light by channel at once and a step for calculating an accumulative energy. At this time, in the step of sensing the channel light by channel at once can sense the channel light of at least two bandwidths different from each other by channel at once among the light illuminated to the board where the light sensor modules 100 to sense the light amount of specific channel light are arranged by a specific channel. At this time, at least two different bandwidths may be bandwidths neighboring with each other, for example, may be the bandwidths to be neighbored continuously. For example, as at least two different bandwidths are neighbored continuously, the accurate light amount can be measured by each channel without the wavelength period omitted in the whole period.

At this time, in one example, the step of sensing the channel light by channel at once can includes a step of reducing the amount of light illuminated from the light source 1, a step of passing the channel light of a specific bandwidth of the reduced light by channel at once and a step of sensing the light amount of the channel light of the past specific bandwidth at once. At this time, each of the steps may be performed by each channel. For example, the amount of the light illuminated from the light source 1 can be reduced by using the ND filter 140 and the channel light of the specific bandwidth of the reduced light can be passed by channel at once by using the BPF 150. And also, the light amount of the channel light of the specific bandwidth passed through the BPF 150 can be sensed by using a plurality of light sensors 110 at once.

And also, reviewing one example of the method for measuring the light source energy by channel, in the step of sensing the channel light by channel at once, amounts of a first channel light of the first wavelength bandwidth including the 365 nm peak (I peak), a second channel light of the second wavelength bandwidth including the 405 nm peak (H peak) and being in neighborhoods with the first wavelength bandwidth and a third channel light of the third wavelength bandwidth including the 436 nm peak (G peak) and being in neighborhoods with the second wavelength bandwidth can be sensed by channel. For example, the first, the second and the third channel light can be sensed by channel at once by using the multi-channel luminous energy sensing unit 10 shown in FIG. 2a and/or FIG. 2b.

At this time, in one example, the first wavelength bandwidth of the first channel light may be ranged from substantially 345 to 385 nm. The second wavelength bandwidth of the second channel light may be ranged from substantially 385 to 425 nm. And also, the third wavelength bandwidth of the third channel light may be ranged from 426 nm to 446 nm. Accordingly, the accurate light amounts can be measured by each channel in the wavelength bandwidth of the whole period to be measured without the substantially omitted wavelength bandwidths with including the I, the H and the G peaks.

And also, reviewing the method for measuring the light energy by channel in accordance with one example, in the step of sensing the channel light by channel, the light amount of at least one channel light among the fourth and the fifth channel lights among the light illuminated from the light source 1 may be further sensed at the same time with the light amounts of the first, the second and the third channel lights.

At this time, the fourth channel light includes the peak of substantially 335 nm and has the fourth wavelength bandwidth being in neighborhoods with the first wavelength bandwidth. For example, the fourth wavelength bandwidth of the fourth channel light may be ranged from substantially 325 to 345 nm.

And also, the fifth channel light includes the peak of substantially 315 nm and has the fifth wavelength bandwidth being in neighborhoods with the fourth wavelength bandwidth. For example, the fifth wavelength bandwidth of the fifth channel light may be ranged from substantially 305 to 325 nm.

For example, as further sensing the fourth and the fifth channel light, the accurate light amounts can be measured in the wavelength bandwidths of the whole period to be measured without being omitted substantially with including the I, the H and the G peaks as well as the peaks of substantially 315 nm and the 335 nm.

As reviewing the method for measuring the light energy by channel in accordance with still another embodiment of the present invention, it can further include a step of sensing the channel light by channel at once and a step of measuring the light illuminated from the light source 1 to the board. For example, the heat of the light illuminated from the light source 1 to the board can be measured by using the multi-channel luminous energy sensing unit 10 which further includes at least one thermocouple module 101.

Thereafter, in the step of calculating the accumulative energy, the accumulative energy is calculated by channel from the light amounts sensed during a predetermined time. The accumulative energy can be calculated by multiplying the intensity of illumination by time.

In accordance with embodiments of the present invention, the energy of desired bandwidth can be obtained accurately in an UV or a visible region emitted in the exposure device. Accordingly, the efficiency of light sources according to time for each exposure device and the affects of the system integrated with a reflection system and a mirror system can be measured. And also, the spectrum changes due to the exposure types between each device can be measured. In the present invention, since the exposure energy difference and the ratio difference between I, H and G can be known as the major factors affecting on the solder resist (SR) process or the like, the fine process management can be allowed.

Embodiments of the invention have been discussed above with reference to the accompanying drawings. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A multi-channel luminous energy sensing unit to sense an amount of light illuminated from a light source, comprising:
a board; and
a plurality of light sensor modules arranged on the board for sensing at least two channel light with bandwidths different from each other among the light illuminated from the light source.

2. The multi-channel luminous energy sensing unit according to claim 1, wherein each of the light sensor modules includes:
a neutral density (ND) filter for reducing the amount of light illuminated from the light source;
a band pass filter (BPF) for passing a channel light with the specific bandwidth among the light passed through the ND filter; and
a light sensor for sensing the amount of light of the channel light with the specific bandwidth passed through the BPF filter.

3. The multi-channel luminous energy sensing unit according to claim 2, wherein each of the light sensor modules further includes:
a window for passing the light illuminated from the light source; and
a diffuser for diffusing the light passed through the window and supplying the diffused light to the ND filter.

4. The multi-channel luminous energy sensing unit according to claim 1, wherein the plurality of light sensor modules includes:
at least one first light sensor module arranged on the board for sensing an amount of light of a first channel light of a first wavelength bandwidth including a peak of substantially 365 nm among the light illuminated from the light source;
at least one second light sensor module arranged on the board for sensing an amount of light of a second channel light of a second wavelength bandwidth, adjacent to the first wavelength bandwidth, including a peak of substantially 405 nm among the light illuminated from the light source; and
at least one third light sensor module arranged on the board for sensing an amount of light of a third channel light of a third wavelength bandwidth, adjacent to the second wavelength bandwidth, including a peak of substantially 436 nm among the light illuminated from the light source.

5. The multi-channel luminous energy sensing unit according to claim 4, wherein the number of the first light sensor modules is greater than the number of the second and the third light sensor modules.

6. The multi-channel luminous energy sensing unit according to claim 4, wherein the first wavelength bandwidth of the first channel light is ranging from substantially 345 to 385 nm, the second wavelength bandwidth of the second channel light is ranging from substantially 385 to 425 nm and the third wavelength bandwidth of the third channel light is ranging from 426 nm to 446 nm.

7. The multi-channel luminous energy sensing unit according to claim 4, wherein the plurality of light sensor modules further comprises at least one light sensor module among at least one fourth light sensor module and at least one fifth light sensor module, wherein
the at least one fourth light sensor module for sensing an amount of light of a fourth channel light of a fourth wavelength bandwidth, adjacent to the first wavelength bandwidth, including a peak of substantially 335 nm among the light illuminated from the light source, and
the at least one fifth light sensor module for sensing an amount of light of a fifth channel light of a fifth wavelength bandwidth, adjacent to the fourth wavelength bandwidth, including a peak of substantially 315 nm among the light illuminated from the light source.

8. The multi-channel luminous energy sensing unit according to claim 7, wherein the fourth wavelength bandwidth of the fourth channel light is ranging from substantially 325 to 345 nm and the fifth wavelength bandwidth of the fifth channel light is ranging from substantially 305 to 325 nm.

9. The multi-channel luminous energy sensing unit according to claim 1, further comprising:
at least one thermocouple module arranged on the board for measuring heat of the light illuminated from the light source.

10. The multi-channel luminous energy sensing unit according to claim 9, wherein the thermocouple module is formed by including a thermocouple sensor for measuring heat and a moisture sensor for measuring moisture.

11. The multi-channel luminous energy sensing unit according to claim 9, further comprising:
a moisture sensor module arranged on the board for measuring moisture.

12. An apparatus for measuring light energy of an exposure device to measure spectrum energy of a light source of the exposure device, comprising:
a multi-channel luminous energy sensing unit for measuring energy by channel of light illuminated from a light source of the exposure device according to claim 1.

13. The apparatus for measuring the light energy of the exposure device according to claim 12, wherein the multi-channel luminous energy sensing unit further includes at least one thermocouple module arranged on the board for measuring heat of the light illuminated from the light source.

14. A method for measuring light energy of light illuminated from a light source by channel, comprising:
sensing channel light with at least two bandwidths different from each other by channel at the same time among the light illuminated to a board where a plurality of light sensor modules of which each senses an amount of light of a specific channel light are arranged by a specific channel; and
calculating accumulated energy by channel from the amount of light sensed during a predetermined time.

15. The method for measuring light energy of light illuminated from a light source by channel according to claim 14, wherein sensing the channel light by channel at the same time includes:
reducing an amount of light illuminated from the light source;
passing a channel light with the specific bandwidth of the reduced light at the same time by channel; and
sensing the amount of the past channel light of with the specific bandwidth at the same time.

16. The method for measuring light energy of light illuminated from a light source by channel according to claim 14, wherein, in sensing the channel light by channel at the same time, a first channel light of a first wavelength bandwidth including a peak of substantially 365 nm, a second channel light of a second wavelength bandwidth, adjacent to the first wavelength bandwidth, including a peak of substantially 405 nm and a third channel light of a third wavelength bandwidth, adjacent to the second wavelength bandwidth, including a peak of substantially 436 nm are sensed at the same time by channel.

17. The method for measuring light energy of light illuminated from a light source by channel according to claim 16, wherein
the first wavelength bandwidth of the first channel light is ranging from substantially 345 to 385 nm;
the second wavelength bandwidth of the second channel light is ranging from 385 to 425 nm; and
the third wavelength bandwidth of the third channel light is ranging from 426 to 446 nm.

18. The method for measuring light energy of light illuminated from a light source by channel according to claim 16, in sensing the channel light by channel at the same time, the amount of light of at least one channel light among a fourth channel light and a fifth channel light is further sensed at the same time, wherein the fourth channel light of a fourth wavelength bandwidth adjacent to the first wavelength bandwidth includes a peak of substantially 335 nm among the light illuminated from the light source and the fifth channel light of a fifth wavelength bandwidth adjacent to the fourth wavelength bandwidth includes a peak of substantially 315 nm.

19. The method for measuring light energy of light illuminated from a light source by channel according to claim 18, wherein
the fourth wavelength bandwidth of the fourth channel light is ranging from substantially 325 to 345 nm; and
the fifth wavelength bandwidth of the fifth channel light is ranging from substantially 305 to 325 nm.

20. The method for measuring light energy of light illuminated from a light source by channel according to claim 14, further comprising:
measuring heat of the light illuminated from the light source to the board at the same time of sensing the channel light by channel at the same time.
